(19) United States
(12) Patent Application Publication
(10) Pub. No.: US 2026/0223761 A1
(43) Pub. Date: Aug. 6, 2026

(54) Method for Differentiating Dust from Non-Dust Objects in Point Cloud Data

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/344,503

(22) Filed: Sep. 29, 2025

Related U.S. Application Data
(60) Provisional application No. 63/753,937, filed on Feb. 4, 2025.

(51) Int. Cl. A01B 69/04; G01S 17/89; G01S 17/931; G06F 18/2323

(52) U.S. Cl. CPC A01B 69/008; G01S 17/89; G01S 17/931; G06F 18/2323

(57) ABSTRACT

Disclosed are autonomous vehicle systems and methods for distinguishing atmospheric phenomena, such as dust clouds, from other objects within an operating environment. Point cloud data received from LiDAR sensors may be classified based on multiple returns from LiDAR sensor beams. Atmospheric phenomena may be classified based on a mean return number or a mean last return ratio, or other return-based parameters, for example, by comparison to a return threshold or through a classification process, such as a machine learning process. The autonomous vehicle may then be driven according to the classification of the point cloud data.

### BACKGROUND

For safe navigation through an environment, autonomous ground vehicles rely on sensory inputs such as cameras, LiDAR, and radar for detection and classification of obstacles and impassable terrain. These sensors provide data representing 3D space surrounding the vehicle. Often this data is obscured by dust, precipitation, objects, or terrain, producing gaps in the sensor field of view.

### SUMMARY

Disclosed are autonomous vehicle systems and methods for distinguishing atmospheric phenomena from other objects within an operating environment. Specifically, the autonomous vehicle system and methods may classify point cloud data based on the multiple returns within a cluster of the point cloud data.

In an embodiment, an autonomous vehicle may comprise a steering control system for autonomously controlling a driving direction of the autonomous vehicle, a speed control system for autonomously controlling a speed of the autonomous vehicle, and one or more sensors, including a LiDAR sensor. The autonomous vehicle may additionally comprise one or more processors communicatively coupled with the one or more sensors, the steering control system, and the speed control system, and one or more computer-readable media having stored thereon instructions or a method that when executed cause the one or more processors to drive the autonomous vehicle system according to a classification of the cluster of point cloud data.

The method may comprise receiving point cloud data from the LiDAR sensor in predetermined time packets, wherein the point cloud data comprises data points indicating at least a portion of an operating environment, and identifying a cluster within the point cloud data, wherein the cluster corresponds to an object within the operating environment and wherein at least one of the data points of the cluster results from a multiple return of a LiDAR beam. Each data point may correspond to a return number that indicates the number of returns obtained from a corresponding LiDAR beam.

The method may then comprise calculating a mean return number associated with the cluster based on all returns of the data points within the cluster. The mean return number may represent an average of the return numbers for all data points within the cluster. A cluster classification based on the mean return number may then be determined, wherein the cluster classification represents an object type of the object within the operating environment corresponding to the cluster. The method may then include instructing a steering control system and a speed control system to drive an autonomous vehicle along a path through the operating environment based on the cluster classification.

The mean return number may be weighted based on an intensity of the point cloud data. Determining the cluster classification may comprise comparing the mean return number to a return threshold or may may comprise inputting the return numbers of the cluster to a classification process comprising at least one of a logistics regression classification, a decision tree, a random forest learning model, a support vector machine, or a neural network. The classification process may be trained to adjust a weight of the return numbers based on at least one of an intensity, reflectivity, elongation, infra-red value, or pulse width of a corresponding point within the cluster.

Determining the cluster classification may be further based on a mean range from the LiDAR sensor to the object corresponding to the cluster, a mean last return ratio (MLRR), a number of points within the cluster, a geometric extent of the cluster, a mean intensity of the points within the cluster, and/or a mean reflectance of the points within the cluster. The cluster classification can include an atmospheric phenomena comprising one of dust, mist, smoke, rain, snow, or fog.

When the cluster classification indicates an atmospheric phenomena, the instructions may further cause the one or more processors to drive the autonomous vehicle along a path through the atmospheric phenomena. When the point cloud data indicates the cluster represents a moving object and the cluster classification indicates an atmospheric phenomena, the instructions may further cause the one or more processors to continue to drive the autonomous vehicle along a path in proximity to but not within the atmospheric phenomena.

When the cluster classification does not indicate an atmospheric phenomena, the instructions may further cause the one or more processors to prevent the autonomous vehicle from driving along a path containing the object, and/or prevent the autonomous vehicle from driving along a path within a proximity threshold of the object. The processor may communicate steering commands to a steering mechanism of the steering control system based on the cluster classification, or may communicate braking commands to a braking mechanism of the speed control system based on the cluster classification.

In another embodiment, the classification process may comprise receiving point cloud data from the LiDAR sensor in predetermined time packets, wherein the point cloud data comprises data points indicating at least a portion of an operating environment and identifying a cluster within the point cloud data, wherein the cluster corresponds to an object within the operating environment and wherein at least one of the data points of the cluster results from a multiple return of a LiDAR beam. Each data point may correspond to a return number that indicates the number of returns obtained from a corresponding LiDAR beam.

The classification process may comprise calculating a mean last return ratio (MLRR). The MLRR may be based on the multiple returns of the data points, wherein the MLRR is determined according to a function comprising:

$$M L R R = \frac{{\sum }_{j = 1}^{j = p} 1 - \frac{{r}_{j} - ( {i}_{j} + 1 )}{{r}_{j}}}{p} .$$

P may represent a total number of points within the cluster, rᵢ may represent a number of returns r at data point j, and iⱼ may represent a return index i at data point j. Variables i and j may be sorted by range where i=0 is the closest return. This equation may be based on a zero-indexed counting system. One skilled in the art could adjust the equation to account for other counting systems.

The process may further comprise determining a cluster classification based on the MLRR, wherein the cluster classification represents an object type of the object within the operating environment. Thereafter, the autonomous vehicle system can instruct a steering control system and a speed control system to drive an autonomous vehicle along a path through the operating environment based on the cluster classification.

The MLRR may be weighted based on an intensity of the point cloud data. Determining the cluster classification may include comparing the MLRR to a return threshold. Additionally, or alternatively, determining the cluster classification may include inputting the MLRR of the cluster to a classification process comprising at least one of a logistics regression classification, a decision tree, a random forest learning model, a support vector machine, or a neural network.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIGS. 1A-1B illustrate a diagram of an autonomous vehicle employing a LiDAR sensor to detect a solid surface within an operating environment.

FIGS. 2A-2B show a diagram of an autonomous vehicle employing a LiDAR sensor to detect a permeable surface within the operating environment.

FIGS. 3A-3B illustrate a diagram of particles within a dust cloud interacting with a LiDAR sensor beam.

FIG. 4 illustrates a process for driving an autonomous vehicle by relying on the classification of a cluster of cloud point data, wherein the cluster classification is based on the mean return number.

FIG. 5 illustrates a process for driving an autonomous vehicle by relying on the classification of a cluster of cloud point data, wherein the cluster classification is based on the mean last return ratio (MLRR).

FIG. 6 shows an illustrative computational system for performing functionality to facilitate implementation of embodiments described in this document.

FIG. 7 illustrates a block diagram of an example autonomous vehicle communication system of the present disclosure.

FIG. 8 is a side view of an autonomous yard truck according to some embodiments.

FIG. 9 is a perspective view of an autonomous mower according to some embodiments.

FIG. 10 is a side view of an autonomous tractor according to some embodiments.

### DETAILED DESCRIPTION

### Introduction

Autonomous vehicles conventionally rely on exteroceptive sensors to navigate through an operating environment. For example, an autonomous vehicle may rely on 3D and/or 2D LiDAR, radar, and/or video cameras to detect objects within an operating environment. Identifying the type of an object may be critical for the autonomous vehicle to successfully perform an operational task. The autonomous vehicle may need to distinguish portions of the operating environment over which it can drive from objects with which the autonomous vehicle must avoid contact. For example, the autonomous vehicle may need to distinguish undulating terrain over which the autonomous vehicle may drive from rocks and trees which could become damaged or result in damage to the vehicle if contact is not avoided.

The autonomous vehicle may additionally need to distinguish animate objects, including animals and people, from the operating environment. Some autonomous vehicle systems may enter into an alert mode that prevents the autonomous vehicle from operating (e.g., from driving through the operating environment or operating an implement of the autonomous vehicle) when the sensor detects an animate object that comes too close to the operating vehicle, so as to minimize the risk of harm to people or animals. However, the sensor may detect the movement of inanimate objects, including atmospheric phenomena, such as dust or mist, that may be generated during the operational task of the autonomous vehicle. Such conditions may be mis-classified by the autonomous vehicle as animate objects upon detection of particulate movement within the atmospheric phenomena. This may result in the autonomous vehicle entering an alert mode and/or an early termination of the operational task, despite that harm to the autonomous vehicle or an animate object is greatly reduced.

Disclosed herein are systems and methods for distinguishing atmospheric phenomena from other animate or inanimate objects based on LiDAR point cloud data. Specifically, the point cloud data may be classified based on the amount of multiple returns received from the object after illuminating the object with a LiDAR beam. Specifically, the mean return number and/or the mean last return ratio (MLRR) may be used to differentiate and classify the objects represented by the point cloud data. In this manner, the identification and classification of objects within the operating environment are improved, leading to increased operational efficiency and safety. For example, the autonomous vehicle may continue to operate when in proximity to an atmospheric condition while maintaining low risk of harm or damage.

### Definitions

As used herein, the term “point cloud data” may refer to a group of data points obtained from LiDAR sensor signal data representing positions located closely together in space, forming a distinct, identifiable region or structure.

As used herein, the term “LiDAR beam” or “beam” may refer to a light originating from a LiDAR laser of a LiDAR sensor used to detect the surfaces within an operating environment.

As used herein, the term “return” may refer to a reflection of the LiDAR beam back to the sensor. Each return may be represented by a data point within the point cloud data. The term “multiple returns” may refer to two or more returns that originated with the same LiDAR beam, but which have reflected from different surfaces or obscurants (e.g., disposed in front of and behind each other).

As used herein, the term “solid surface” may refer to a non-penetrable surface that typically only provide one return per LiDAR beam.

As used herein, the term “permeable surface” may refer to a stratified or layered surface that may provide multiple returns per LiDAR beam.

As used herein, the term “atmospheric phenomena” or related terms may refer to a suspension or aerosol of particulate or droplets suspended in air. Atmospheric phenomena within the operating environment may include, for example, dust clouds, smoke, mist, fog, rain, snow, or other obscurant. Atmospheric phenomena may typically exhibit more multiple returns than either solid or permeable surfaces when reflecting a LiDAR beam.

### Multiple Returns

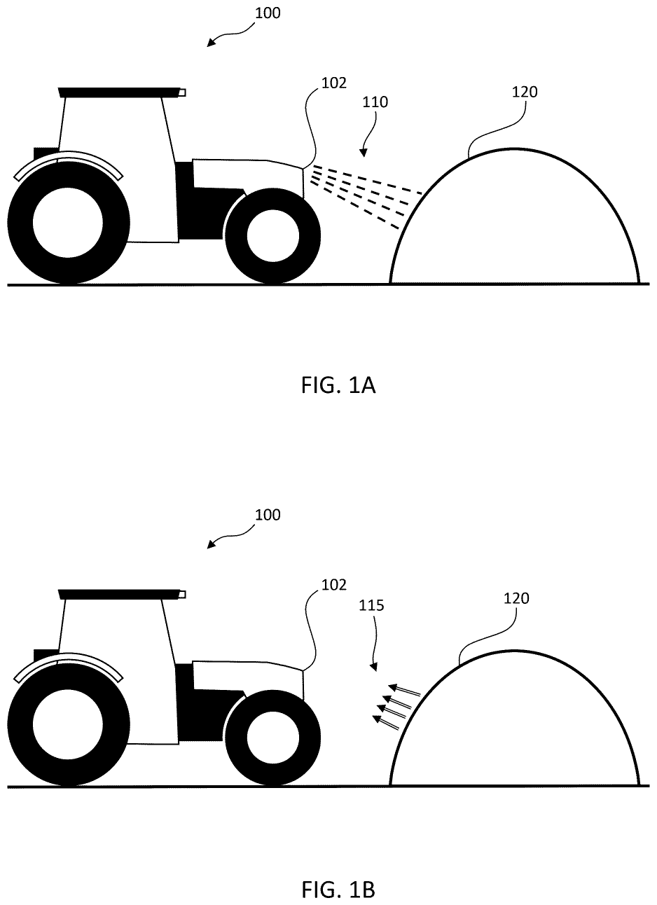

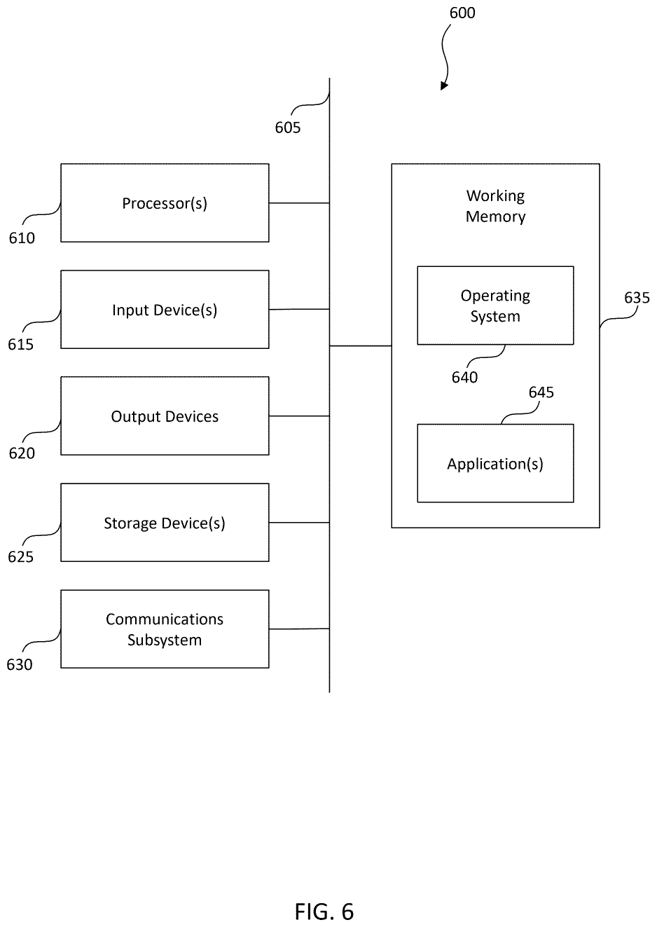

FIGS. 1A and 1B illustrate an autonomous vehicle 100. The autonomous vehicle 100 may comprise an autonomous tractor (as shown) or other autonomous vehicle (such as those described in relation to FIGS. 6-10 below). However, one skilled in the art will understand that the disclosed system and methods may be practiced with other autonomous vehicles, or may be used in other vehicles or devices that use point cloud data received from light detection and ranging (LiDAR) sensors to map an operating environment.

The autonomous vehicle 100 may comprise one or more LiDAR sensors disposed about an exterior (e.g., at a front 102) of the autonomous vehicle 100. LiDAR is an active remote sensing system used to measure distance from the sensor to an object. LiDAR sensors function by emitting light in one or more beams away from the sensor towards an object in an operating environment. When the beam strikes the object, it may reflect in what is called a “return beam,” or simply a “return,” and travel back to the LiDAR sensor for detection. The time between sending the beam and receiving the return may then be used to estimate the distance between the sensor and the object.

Data points may be associated with each return received by the LiDAR sensor, and which may correspond to information regarding the return, including the time between sending and receiving the beam and return, the reflectivity of the object, the intensity of the return, or other information. The totality of the data points (e.g., gathered within a time frame, within a general location) may be referred to as “point cloud data.”

A beam generally comprises multiple photons. At times, some of the photons may strike a front surface while other photons may continue onwards un-obstructed. This may result in some of the photons emitted with the original beam reflecting back to the sensor at different times (i.e., multiple returns).

Each return of the multiple returns may be similarly represented as a data point within the point cloud data. Each data point may correspond to or comprise several attributes. These attributes may include a return number and a return index. The return number may refer to the number of returns generated by the originating beam. For example, if a LiDAR sensor beam resulted in three returns, then each of the three data points respectively associated with the three returns would each have a return number of three. The return index may refer to the order (0-based) in which the return was received by the LiDAR sensor. Thus, returning to the above example of three returns, the first return would have a return index of 0, the second return would have a return index of 1, and the third return would have a return index of 2. The data point attributes may further include an intensity of the return, a reflectivity associated with the return, the infra-red value (e.g., of the beam and/or return), elongation, pulse width, a signal-to-noise ratio, or other attributes.

Generally, when a LiDAR beam is directed to a single surface only one return associated with that beam will occur. For example, FIG. 1A illustrates the beams 110 of the 3D LiDAR sensor emanating from the autonomous vehicle 100 to strike the single surface of the solid object 120. Thereafter, FIG. 1B illustrates that one return 115 per beam 110 may reflect back towards the 3D LiDAR sensor of the autonomous vehicle 100. The time between sending the beams 110 and receiving the returns 115 may be used to calculate a distance between the LiDAR sensor and the object 120.

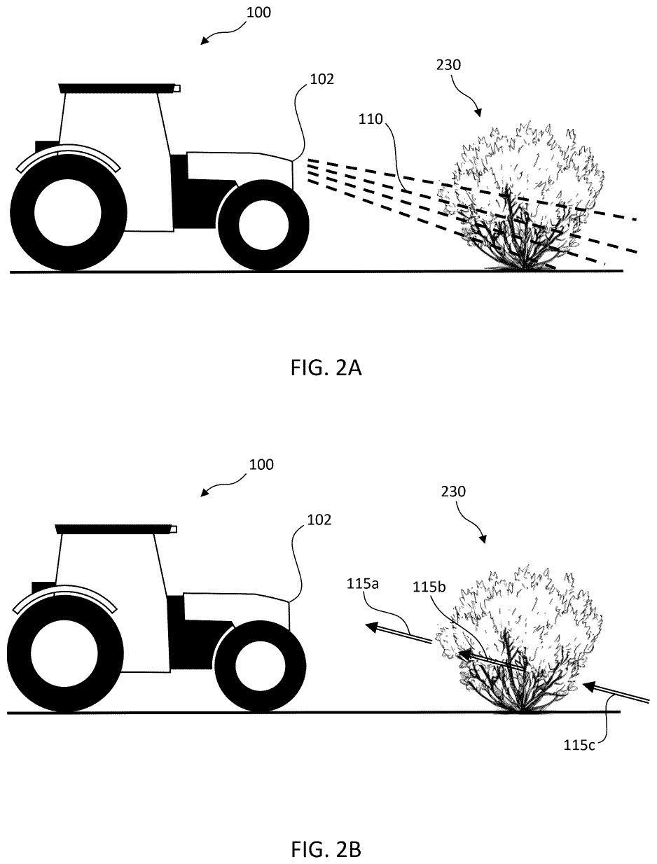

FIGS. 2A and 2B illustrate that the beams 110 and returns 115a, 115b, 115c may behave differently for other surfaces and materials. When the beams 110 reach a penetrable material, such as foliage or an atmospheric phenomena, a portion of the beam 110 may strike a front-most surface closest to the sensor, while the remainder of the beam 110 continues on to strike one or more rear surfaces disposed further from the sensor. FIGS. 2A and 2B illustrate the LiDAR sensor beams 110 as they attempt to detect the foliage of a bush 230. This results in multiple returns, including returns 115a, 115b, 115c, wherein return 115a can occur after the beam 110 has struck a front surface of the bush 230, return 115b can occur after the beam 110 has struck a rear surface of the bush 230 (e.g., an interior branch of the bush 230), and return 115c can occur after the beam 110 has struck a rear-most surface (e.g., a ground surface of the operating environment).

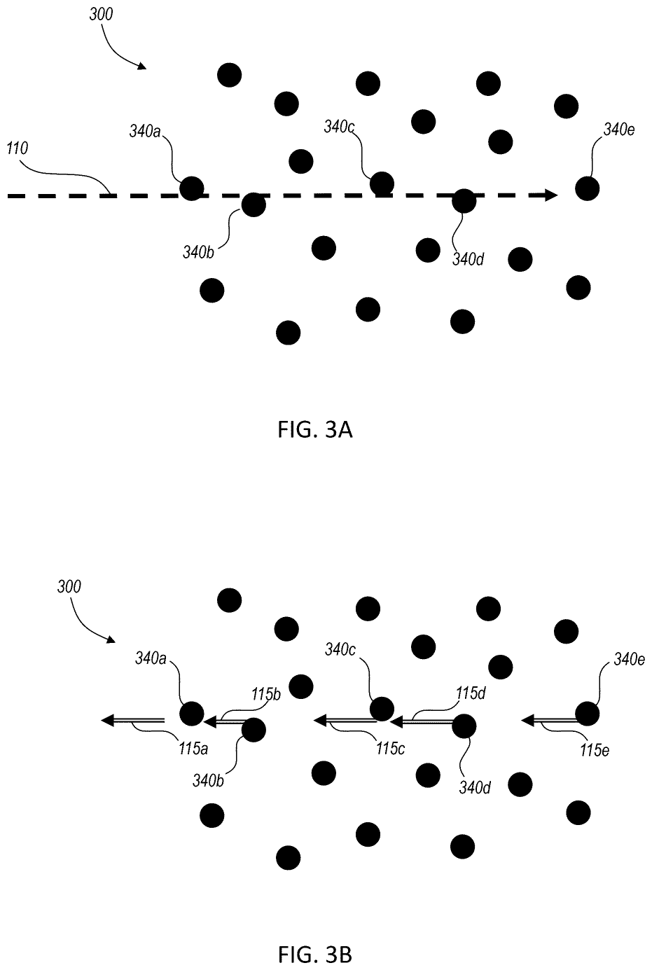

FIGS. 3A and 3B illustrate a LiDAR beam 110 as it interacts with the particles 340a, 340b, 340c, 340d, 340e of an atmospheric phenomena comprising a dust cloud 300. The atmospheric phenomena may comprise a dust cloud 300 or may comprise another phenomena, such as rain, fog, snow, mist, smoke, or other atmospheric debris. The beam 110 may be obstructed only partially by each particle 340a, 340b, 340c, 340d, 340e of the dust cloud 300. In this manner, multiple returns 115a, 115b, 115c, 115d, 115e may reflect from the dust cloud 300.

The atmospheric phenomena may reflect more returns 115a, 115b, 115c, 115d, 115e when compared to less-penetrable materials. For example, while the foliage of a tree or bush may provide three to five returns, the particles of the above atmospheric phenomena may produce five, six, seven, eight, nine, ten, or more than ten returns. This difference in the amount of returns 115a, 115b, 115c, 115d, 115e may be used to classify the objects within the operating environment and distinguish atmospheric phenomena from other objects. However, in some instances, the number of returns may not be sufficient to distinguish between atmospheric phenomena and other less-penetrable materials.

### Classification Processes

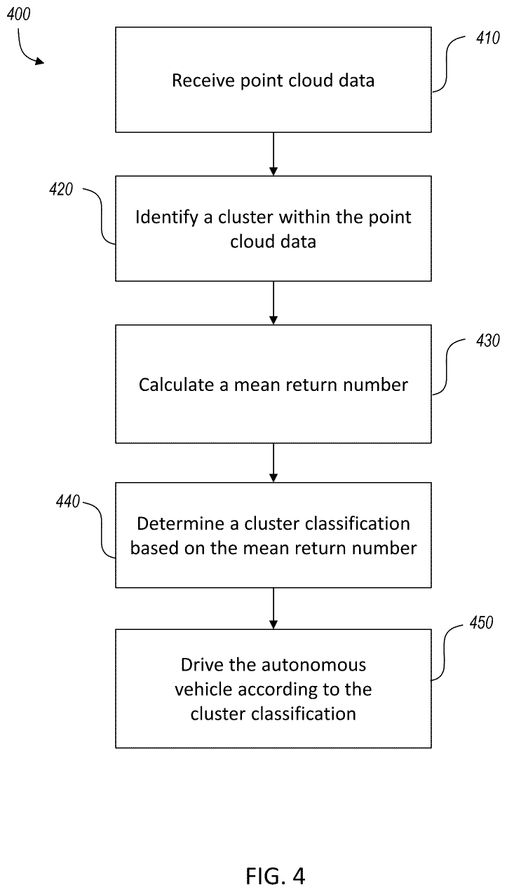

FIG. 4 illustrates a process 400 for classifying point cloud data. The process 400 may include in a first step 410 receiving point cloud data in predetermined time packets from a LiDAR sensor. The point cloud data may include one or more data points that indicate (e.g., contain information regarding) at least a portion of the operating environment, wherein at least a portion of the one or more points comprise multiple returns.

A cluster may then be identified within the point cloud data at step 420. A cluster may refer to a group of data points within the point cloud data that correspond to positions within the operating environment that are located closely together in space, and which may form a distinct, identifiable region or structure. For example, a cluster may refer to all or a portion of the points within the point cloud data that represent or correspond to a distinct object within the operating environment. That is, the cluster may refer to all or a portion of the atmospheric phenomena (e.g., the dust cloud 300). Identification of the cluster may include segmentation or other pre-processing techniques known in the art for identifying data points as belonging to a group associated with an object.

Thereafter, at step 430, a mean return number may be calculated. The mean return number may be calculated as the average return number for all points within the cluster, and which may be calculated, for example, by obtaining the sum of all the return numbers for all data points within the cluster and dividing the sum by the number of data points within the cluster. The return numbers may be weighted when used to calculate the mean return number. For example, the return numbers of each data point may be weighted according to the intensity of the return, the reflectivity of the return, the infra-red value, elongation, pulse width, the signal-to-noise ratio, or any other attribute of the data points of the cluster. Additionally, or alternatively, the return numbers may be weighted according to parameters including the geometric extent of the cluster (or of the object associated with the cluster), the distance of the object from the LiDAR sensor, and/or the number of data points within the cluster. In some embodiments, the return numbers may be weighted according to a machine learning model that takes as input any one or more of the attributes described above or other indicators. Additionally, or alternatively, the mean return number may be weighted according to the same or similar parameters during the classification process, described below.

Step 440 comprises determining a cluster classification associated with the cluster. The cluster classification may represent the object type associated with the object on which the point cloud data of the cluster is based. The cluster classification may comprise multiple groups, including atmospheric phenomena (including air suspensions or other phenomena that provide greater amounts of multiple returns), permeable surfaces (including stratified surfaces, such as foliage, that provide lower amounts of multiple returns), and solid surfaces (i.e., surfaces that typically only provide one return per LiDAR beam). The atmospheric phenomena classification may correspond to and/or include phenomena such as dust, mist, smoke, rain, snow, or fog. The permeable surface classification may correspond to and/or include object types such as foliage, dirt, or fencing—objects that are likely to obstruct photons at different surface, but which are likely to provide a relatively low amount of multiple returns. The solid surface classification may include objects that are likely to provide only a single return per originating LiDAR beam, and which may not comprise further-disposed surfaces behind front surfaces that may lie along a direct line of sight from the LiDAR sensor.

The cluster classification may be based on the mean return number. For example, the mean return number may be compared to one or more return thresholds. Each group of the cluster classification may be associated with a return threshold. For example, the default cluster classification may be a solid surface classification. The permeable surface classification may be associated with a first return threshold, such as a threshold of three returns, such that when the mean return number is equal to or greater than three returns then the cluster is classified as a permeable surface. The atmospheric phenomena classification may be associated with a second return threshold, such as a threshold of five returns, such that if the mean return number is equal to or greater than five returns then the cluster is classified as an atmospheric phenomena. In another example, the permeable surface classification and the atmospheric phenomena classification may be associated with a threshold of two returns, such that when the mean return number is equal to or greater than two returns, the cluster is classified as a permeable surface or an atmospheric phenomena.

Alternatively, the cluster classification may be based on inputting the return numbers and/or the mean return number to a classification process. The classification process may comprise a logistics regression classification, a decision tree, a random forest learning model, a support vector machine, or a neural network. The classification process may receive as input any of the attributes, indicators, or weighting parameters related to calculation of the mean return number described above. The classification process may be trained to adjust a weight associated with any and/or all of the inputs to the classification process, including the return number and/or mean return number. For example, the classification process may be trained to adjust a weight of the return number based on an intensity, reflectivity, elongation, infra-red value, or pulse width of a corresponding point within the cluster.

Finally, in step 450, the autonomous vehicle system may drive the autonomous vehicle 100 according to the cluster classification. Specifically, the autonomous vehicle system may instruct a steering control system and a speed control system to drive an autonomous vehicle 100 along a path through the operating environment based on the cluster classification.

When the cluster is classified as an atmospheric phenomena, the autonomous vehicle 100 may continue to perform towards completing the operational task. For example, when the cluster is classified as an atmospheric phenomena, the autonomous vehicle 100 may drive along a path through the atmospheric phenomena.

When the cluster is classified as an atmospheric phenomena, the autonomous vehicle 100 may be enabled to continue to operate, but may optionally operate within an alert mode that restricts operation of the autonomous vehicle 100. The restrictions of the safety mode may depend on one of several factors, such as the distance from the autonomous vehicle 100 to the positions associated with the cluster and the operational task to be performed.

When the cluster classification indicates an atmospheric phenomena, the autonomous vehicle system may continue to drive the autonomous vehicle 100 along a path in proximity to but not within the atmospheric phenomena. For example, the autonomous vehicle 100 may continue to drive beyond a proximity threshold of the position associated with the cluster (i.e., beyond a proximity threshold of the atmospheric condition). The proximity threshold may be set to reduce the risk of harm to nearby animate (e.g., people) and inanimate objects (buildings), depending on the operational task of the autonomous vehicle 100. For example, the proximity threshold may be set to a distance of 1, 2, 3, 4, 5, 6, 7, 8, 9, 10, 11, 12, or more than 12 feet, or may be set within a range having any two of the foregoing as endpoints. The autonomous vehicle 100 may be driven within or beyond a threshold when the autonomous vehicle system recognizes the atmospheric phenomena as a moving object (e.g., as the dust cloud moves through the operating environment).

For example, when the point cloud data indicate that the cluster represents a moving object and the cluster classification indicates an atmospheric phenomena, the autonomous vehicle 100 may drive along a path in proximity to but not within the atmospheric phenomena.

When the cluster classification indicates an atmospheric phenomena, the autonomous vehicle system may continue to drive the autonomous vehicle 100 along a path at a reduced speed (e.g., when the autonomous vehicle 100 is within the proximity threshold). This may give, for example, enough time to enable the autonomous vehicle system to stop and prevent movement of the autonomous vehicle 100 if an animate object emerges from the atmospheric phenomena at moderate speed. In some embodiments, when the cluster classification indicates an atmospheric phenomena, the data points of the cluster may not be used at all to navigate the autonomous vehicle 100.

Additionally, or alternatively, when the cluster classification does not indicate an atmospheric phenomena, the autonomous vehicle system can prevent the autonomous vehicle 100 from driving along a path containing the object, and/or prevent the autonomous vehicle 100 from driving along a path within a proximity threshold of the object.

### Mean Last Return Ratio

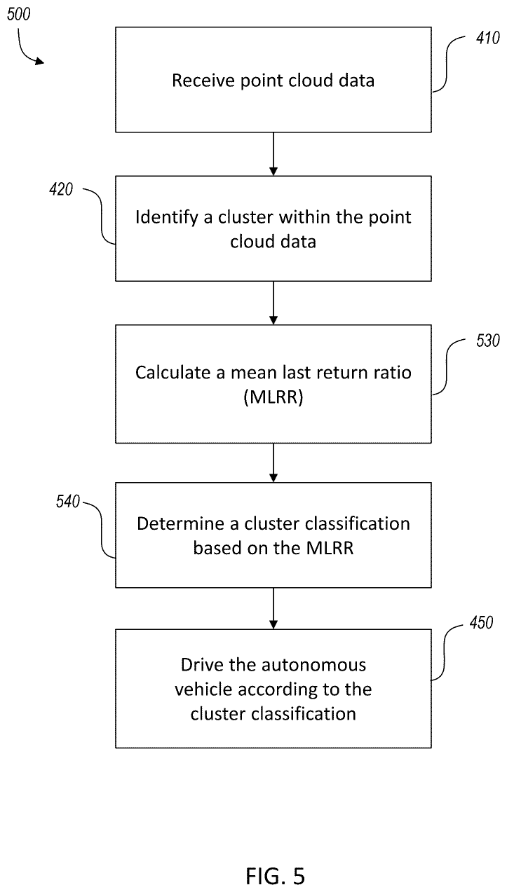

FIG. 5 illustrates another process 500 similar to process 400 for classifying point cloud data. Similar to process 400, process 500 may comprise steps 410 and 420 for receiving point cloud data from a LiDAR sensor that indicates at least a portion of the operating environment and identifying a cluster (e.g., associated with an object of the operating environment) within the point cloud data, the cluster comprising one or more data points exhibiting multiple returns.

In step 530, the process 500 may continue by calculating a mean last return ratio (MLRR) based on the multiple LiDAR returns of the one or more points. A last return ratio (LRR) may be associated with each data point which may depend on the return number and the return index described above. The LRR may be determined according to the following function:

$$L R R = 1 - \frac{r - ( i + 1 )}{r} ,$$

where r represents the return number and i represents the return index of the data point. For example, the third return (i.e., i=2 using a zero-index convention) received from a total of five returns (i.e., r=5) generated by a single LiDAR sensor beam may have an LRR of 0.6. The LRR may extend between a value of 0 and 1 and may represent the amount of multiple returns represented by the data points within the cluster. A lower LRR number may indicate that the returns of the data point reflect from positions disposed generally forward compared to the returns of other data points, such that an LRR near 1.0 may indicate that the returns of the data point reflected behind the returns of other data points, while an LRR near 0 may indicate that the returns of the data point reflected forward of the returns of other data points.

In some instances, the LRR may indicate the number of returns associated with the data point. For example, a lower number may indicate that the data point is associated with a greater number of multiple returns, with an LRR near 1.0 indicating that the data point is associated with few or no multiple returns, while an LRR near 0 indicating that the data point is associated with a relatively large amount of multiple returns.

The MLRR of the cluster may then be determined by obtaining an average of each LRR for all data points within the cluster, such that the MLRR may be determined according to the following function:

$$M L R R = \frac{{\sum }_{j = 1}^{j = p} 1 - \frac{{r}_{j} - ( {i}_{j} + 1 )}{{r}_{j}}}{p}$$

wherein p represents a total number of points within the cluster, rᵢ represents the return number r at data point j, and iⱼ represents a return index i at data point j. The return indices i may ordered by range, where i=0 is the closest return. The return number r or the return index i, when calculating the LRR or MLRR, may be weighted according to the same or similar attributes and parameters (e.g., an intensity or reflectivity) described relating to the mean return number. The LRR or MLRR, when used obtain the cluster classification (described below), may also be weighted according to the same or similar parameters (e.g., geometric extent of the cluster) described relating to the mean return number.

The process 500 may then continue to step 540 for determining a cluster classification based on the MLRR. Specifically, the cluster classification may represent an object type of the object within the operating environment associated with the cluster. The MLRR may be similarly used to classify the cluster as non-atmospheric phenomena, such as a solid surface or a permeable surface. The MLRR may be compared to a return threshold in a similar manner described above in relation to the mean return number. For example, determining the cluster classification may include one or more thresholds, including a lower threshold and an upper threshold. When the MLRR is equal to or greater than the upper threshold the cluster classification may be set to a solid surface classification, when the MLRR is between the upper and lower thresholds the cluster classification may be set to a permeable surface classification, or when the MLRR is equal to or less than the lower threshold the cluster classification may be set to the atmospheric phenomena classification.

The upper threshold may be set at a value of approximately 0.40, 0.45, 0.50, 0.55, 0.60, 0.65, 0.70, 0.75, 0.80, 0.85, 0.90, or 0.95, or may be set within a range having any two of the foregoing as endpoints. Similarly, the lower threshold may be set at a value of approximately 0.05, 0.10, 0.15, 0.20, 0.25, 0.30, 0.35, 0.40, 0.45, 0.50, 0.55, 0.60, 0.65, or 0.70, or may be set within a range having any two of the foregoing as endpoints. In some embodiments, the upper and lower thresholds may be set based on labeled (e.g., training) data provided to a machine learning algorithm.

In some embodiments, the cluster classification may be determined based on inputting the MLRR to a classification process comprising at least one of a logistics regression classification, a decision tree, a random forest learning model, a support vector machine, or a neural network. The MLRR, or other inputs to the classification process, may be weighted in a manner similar to that of the mean return number described above.

Finally, the process 500 may comprise instructing sub-system(s) (e.g., the steering control and/or speed control system) to drive the autonomous vehicle 100 along a path through the operating environment based on the cluster classification.

### Autonomous Vehicle Systems

The computational system 600, shown in FIG. 6, can be used to perform any of the embodiments of the invention. For example, computational system 600 can be used to execute processes 400 and/or 500. As another example, computational system 600 can be used to perform any calculation, identification, and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard, and/or the like; and one or more output devices 620, which can include without limitation a display device, a printer, and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

The computational system 600 may be configured to operate an autonomous vehicle platform. The term “autonomous vehicle”, and related terms (e.g., “autonomous vehicle platform”), as used herein may include manned vehicles, remote control vehicles, and/or manual vehicles, etc. The autonomous vehicle platform may comprise a steering mechanism in communication with the processor, where the processor communicates steering commands to the steering mechanism based on, for example, the cluster classification. The autonomous vehicle platform may comprise a braking mechanism in communication with the processor, where the processor communicates braking commands to the braking mechanism based on, for example, the cluster classification.

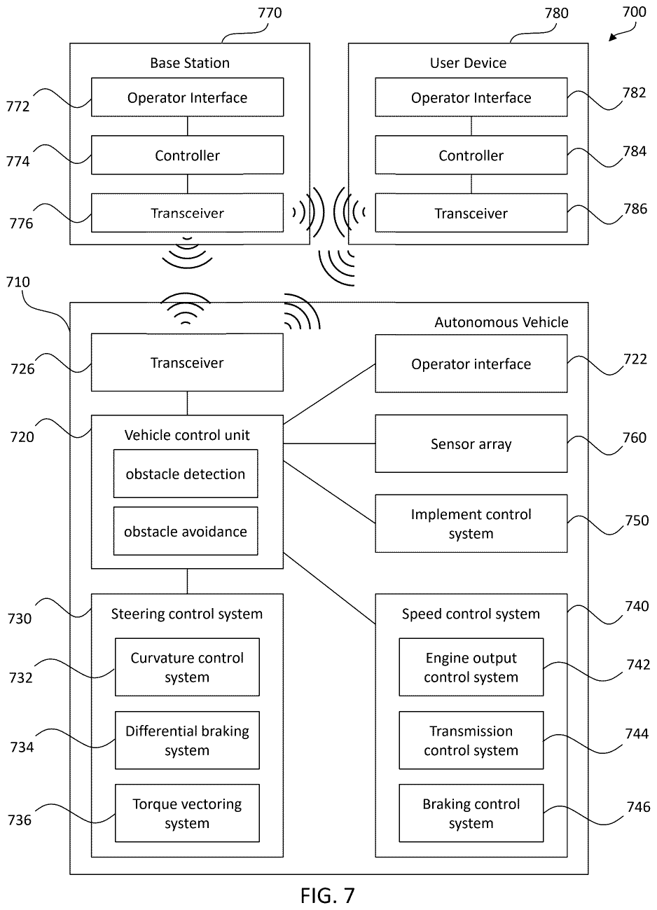

FIG. 7 is a block diagram of a communication and control system 700 that may be utilized in conjunction with the systems and methods of the disclosure. The communication and control system 700 may include a vehicle control unit 720 which may be mounted on an autonomous vehicle 710. The autonomous vehicle 710, for example, may include a yard truck, loader, wheel loader, track loader, dump truck, digger, backhoe, forklift, mower (e.g., lawn, field, or brush mower), or other vehicle. The communication and control system 700, for example, may include any or all components of computational system 600 shown in FIG. 6.

For example, the autonomous vehicle 710 may include a steering control system 730 that may control a direction of movement of the autonomous vehicle 710. The steering control system 730, for example, may include any or all components of computational system 600 shown in FIG. 6.

The autonomous vehicle 710, for example, may include a speed control system 740 that controls the speed, acceleration, and deceleration of the autonomous vehicle 710. The speed control system 740, for example, may control the speed of the autonomous vehicle 710 based on map data, control algorithms, obstacle detection, start and/or stop points, input from the operator (e.g., a remote operator), etc. The speed control system 740, for example, may include any or all components of computational system 600 shown in FIG. 6.

The autonomous vehicle 710, for example, may include an implement control system 750 that may control operation of an implement towed by the autonomous vehicle 710, integrated within the autonomous vehicle 710, or coupled to the autonomous vehicle 710. The implement control system 750, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 750, for example, may include any or all components of computational system 600 shown in FIG. 6.

The vehicle control unit 720 may be communicatively coupled with the steering control system 730, the speed control system 740, and/or the implement control system 750. The vehicle control unit 720, for example, may include any or all of the components shown in FIG. 6. The vehicle control unit 720, for example, may be integrated into a single controller or may include a plurality of distinct components or controllers. The vehicle control unit 720 may also be coupled with one or more sensors from the sensor array 760 and receive sensor data from the sensor array 760.

The vehicle control unit 720, for example, may be used to control various aspects of the vehicle 710 such as, for example, sending instructions to the steering control system 730, implement control system 750, speed control system 740, etc. The vehicle control unit 720, for example, may include a vehicle artificial intelligence (VAI) that may include one or more processors that execute one or more algorithms, including processes 400 and/or 500 disclosed above.

The vehicle control unit 720, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 760 or from a base station 770 (described below).

The vehicle control unit 720, for example, may be an electronic controller with electrical circuitry configured to process data from the various components of the autonomous vehicle 710. The vehicle control unit 720 may include a processor, such as the processor 610, and a working memory 635. The vehicle control unit 720 may also include one or more storage devices, storage media, and/or other suitable components of computational system 600. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 720, for example, may include any or all the components shown in FIG. 6.

The vehicle control unit 720, for example, may include a volatile memory, such as random access memory (RAM), and/or a nonvolatile memory, such as ROM (e.g., working memory 635, storage device 625, and/or other computer-readable media). The memory may store a variety of information and may be used for various purposes. For example, the memory may store processor-executable instructions (e.g., firmware or software) for the vehicle control unit 720 to execute, such as instructions for calculating a drivable path plan, and/or controlling the autonomous vehicle 710 (e.g., for implementing processes 400 or 500 above). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 730, for example, may include a curvature rate control system 732, a differential braking system 734, a steering mechanism, and a torque vectoring system 736 that may be used to steer the autonomous vehicle 710. The curvature rate control system 732, for example, may control a direction of an autonomous vehicle 710 by controlling a steering control system of the autonomous vehicle 710 with a curvature rate, such as an Ackerman style autonomous vehicle, 710 or articulating vehicle. The curvature rate control system 732, for example, may automatically rotate one or more wheels or tracks of the autonomous vehicle 710 via hydraulic or electric actuators to steer the autonomous vehicle 710. By way of example, the curvature rate control system 732 may rotate front wheels/tracks, rear wheels/tracks, and/or intermediate wheels/tracks of the autonomous vehicle 710 or articulate the frame of the vehicle, either individually or in groups. The differential braking system 734 may independently vary the braking force on each lateral side of the autonomous vehicle 710 to direct the autonomous vehicle 710. Similarly, the torque vectoring system 736 may differentially apply torque from the engine to the wheels and/or tracks on each lateral side of the autonomous vehicle 710. While the illustrated steering control system 730 includes the curvature rate control system 732, the differential braking system 734, and the torque vectoring system 736, the steering control system 730 may include one or more of these systems. Further examples may include a steering control system 730 having other and/or additional systems to facilitate turning the autonomous vehicle 710 such as an articulated steering control system, a differential drive system, and the like.

The speed control system 740, for example, may include an engine output control system 742, a transmission control system 744, and a braking control system 746. The engine output control system 742 may vary the output of the engine to control the speed of the autonomous vehicle 710. For example, the engine output control system 742 may vary a throttle setting of the engine, a fuel/air mixture of the engine, a timing of the engine, and/or other suitable engine parameters to control engine output. In addition, the transmission control system 744 may adjust gear selection within a transmission to control the speed of the autonomous vehicle 710. Furthermore, the braking control system 746 may adjust the braking force to control the speed of the autonomous vehicle 710. While the illustrated speed control system 740 includes the engine output control system 742, the transmission control system 744, and the braking control system 746, the speed control system 740 may include one or two of these systems. The speed control system 740, for example, may also include other systems and/or additional systems that may be used to control the speed of the autonomous vehicle 710.

The implement control system 750, for example, may control various parameters of the implement towed by and/or integrated within the autonomous vehicle 710. For example, the implement control system 750 may instruct an implement controller via a communication link, such as a CAN bus, ISOBUS, Ethernet, wireless communications, and/or Broad R Reach type Automotive Ethernet, etc.

The implement control system 750, for example, may instruct an implement controller to adjust a penetration depth of at least one ground engaging tool of an agricultural implement, which may reduce the draft load on the autonomous vehicle 710.

The implement control system 750, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc. The implement control system 750, as another example, may instruct the implement controller to adjust a shovel height, a shovel angle, a shovel position, etc.

The communication and control system 700, for example, may include a sensor array 760. The sensor array 760, for example, may facilitate determination of condition(s) of the autonomous vehicle 710 and/or the work area. For example, the sensor array 760 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous vehicle 710. The sensors may also monitor operating levels (e.g., temperature, fuel level, etc.) of the autonomous vehicle 710. Furthermore, the sensors may monitor conditions in and around the work area, such as temperature, weather, wind speed, compass, humidity, and other conditions. The sensors of the sensor array 760, for example, may detect physical objects in the work area, such as a parking stall, a material stall, accessories, other vehicles, obstacles, environmental features, or other object(s) that may be in the area surrounding the autonomous vehicle 710.

The sensor array 760, for example, may include a velocity sensor which may include one or more of an inertial measurement unit, a compass, a GPS sensor, a wheel encoder, a tachometer, a camera, a radar, etc. The sensor array 760, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous vehicle 710 may include an operator interface 722 for controlling the vehicle. The operator interface 722, for example, may be communicatively coupled to the vehicle control unit 720 and configured to present data from the autonomous vehicle 710 via a display. Display data may include data associated with operation of the autonomous vehicle 710, data associated with operation of an implement, a position of the autonomous vehicle 710, a speed of the autonomous vehicle 710, a desired path, a drivable path plan, a target position, and/or a current position, etc. The operator interface 722 may enable an operator to control certain functions of the autonomous vehicle 710 such as starting and stopping the autonomous vehicle 710, inputting a desired path, etc. The operator interface 722, for example, may enable the operator to input parameters that cause the vehicle control unit 720 to adjust the drivable path plan. For example, the operator may provide an input requesting that the desired path be acquired as quickly as possible, that an off-path normal error be minimized, that a speed of the autonomous vehicle 710 remain within certain limits, and/or that a lateral acceleration experienced by the autonomous vehicle 710 remain within certain limits, etc. In addition, the operator interface 722 (e.g., via the display, or via an audio system (not shown), etc.) may alert an operator if the desired path cannot be achieved, for example.

The communication and control system 700, for example, may include a base station 770 having a base station controller 774 located remotely from the autonomous vehicle 710. For example, the control functions of the vehicle control unit 720 may be distributed between the vehicle control unit 720 of the autonomous vehicle 710 and the base station controller 774. The base station controller 774, for example, may perform a substantial portion of the control functions of the vehicle control unit 720. For example, a first transceiver 726 positioned on the autonomous vehicle 710 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 776 at the base station 770. The base station controller 774, for example, may calculate drivable path plans and/or output control signals to control the curvature control system 732, the speed control system 740, and/or the implement control system 750 to direct the autonomous vehicle 710 toward the desired path, for example. The base station controller 774 may include a processor and memory device having similar features and/or capabilities as the processor and the memory device discussed previously. Likewise, the base station 770 may include an operator interface 772 having a display, which may have similar features and/or capabilities as the operator interface 722 and the display discussed previously.

In some embodiments, one or both of the base station 770 and/or the autonomous vehicle 710 may be in communication with a user device 780. A user device 780 may include a phone, tablet, laptop, or computer. The user device 780 may similarly include an operator interface 782 which may include similar features and capabilities as operator interfaces 722, 772 described above. Additionally, or alternatively, the user device 780 may comprise a controller 784 that may include the same or similar features, components, and/or characteristics as the controller 774 of the base station 770. For example, the user device controller 774 may calculate drivable path plans, output control signals to control the curvature control system 732, the speed control system 740, and/or the implement control system 750 to direct the autonomous vehicle 710. The user device 780, for example, can include an application that allows the user (e.g., a remote operator) to communicate commands to the autonomous vehicle 710 (e.g., via a transceiver 786) and/or receive information about the autonomous vehicle 710. Alternatively, or additionally, the user device 780, for example, can include an application that allows the operator to observe the autonomous vehicle 710 move through a map of the work area where the autonomous vehicle operates.

The user device 780, for example, may include an application that can receive an indication associated with the remote operator or which can receive other user or operator inputs. The user device 780, for example, may include an application that can display any of the information disclosed in this document.

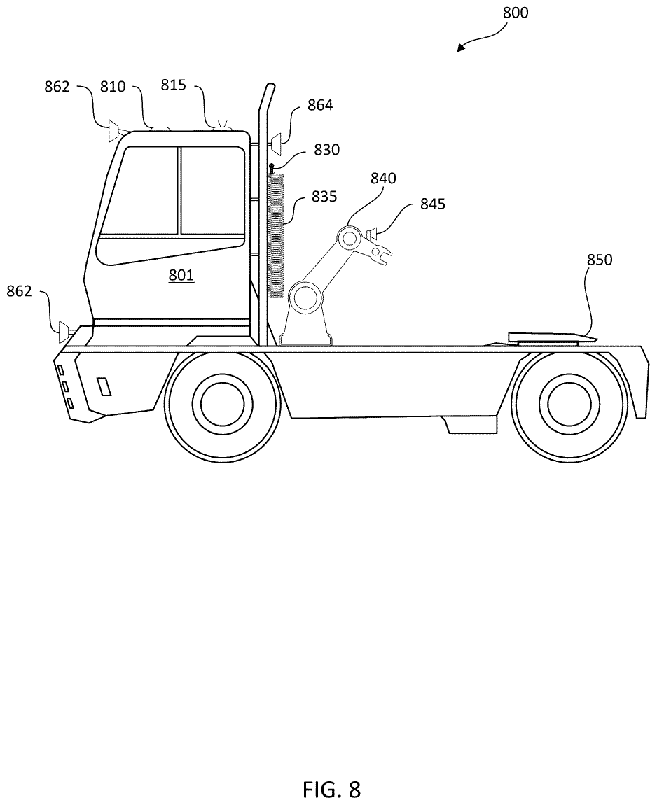

FIG. 8 is a side view of an autonomous yard truck 800 according to some embodiments. The autonomous yard truck 800 includes a cab 801 that may be used to drive the autonomous yard truck 800 manually. The autonomous yard truck 800 may include one or more of the components shown in FIG. 7. The autonomous yard truck 800 may also include a brake system, an engine, a transmission, steering, sensor array, etc. such as, for example, as shown in FIG. 7.

In some embodiments, the autonomous yard truck 800 may include a sensor array that includes sensors 862 (e.g., sensor array 760) disposed at various locations on the autonomous yard truck 800 such as, for example, on the cab 801, bumper, housing, frame, etc. The sensors 862 may include infrared sensors, ultrasonic sensors, magnetic sensors, radar sensors, LiDAR sensors, terahertz sensors, sonar sensors, cameras, etc. The sensor array of the autonomous yard truck 800 may also include one or more backup sensors 864 such as, for example, infrared sensors, ultrasonic sensors, magnetic sensors, radar sensors, LiDAR sensors, terahertz sensors, sonar sensors, cameras, etc.

In some embodiments, the autonomous yard truck 800 may include a spatial locating device (or GPS) antenna 810. In some embodiments, the autonomous yard truck 800 may include a transceiver antenna 815.

In some embodiments, the autonomous yard truck 800 may include one or more hoses 835 that can connect with a trailer such as, for example, two or three hoses. Each hose may have a hose connector 830 that can connect with a trailer hose connector. For example, the one or more hoses 835 of the autonomous yard truck 800 may include a service brake hose, an emergency brake hose, and/or a refrigerant hose.

In some embodiments, the autonomous yard truck 800 may include a robotic arm 840 disposed on the back bed of the autonomous yard truck 800. The robotic arm 840 may include any type of robotic arm. The robotic arm 840, for example, may exert high torque or high pressure sufficient to connect the hose connector 830 with the trailer hose connector. The hose connector 830 and/or the trailer hose connector may comprise a glad-hand connector. In some embodiments, when the autonomous yard truck 800 is not coupled with a trailer, the hose connector 830 may be positioned in a storage rack at some point on the autonomous yard truck 800 such as, for example, on the rear of the cab 801.

In some embodiments, the robotic arm 840 may include one or more arm sensors 845 such as, for example, infrared sensors, ultrasonic sensors, magnetic sensors, radar sensors, LiDAR sensors, terahertz sensors, sonar sensors, cameras, etc. The arm sensor 845, for example, may produce data that can be used to identify the location of a hose connector 830 and/or a trailer hose connector. The arm sensor 845, for example, may produce data that can show that a hose connector 830 and/or a trailer hose connector are sufficiently coupled.

In some embodiments, the autonomous yard truck 800 may include a fifth-wheel coupling 850. The fifth-wheel coupling 850, for example, may be raised or lowered with a fifth-wheel coupling boom. FIG. 8 shows the fifth-wheel coupling 850 in a lowered position. The fifth-wheel coupling 850 may couple with a kingpin of a trailer.

When the fifth-wheel coupling 850 is coupled with a kingpin and the fifth-wheel coupling 850 is in the raised position, the legs of the trailer may lift off the ground (e.g., automatically). This may allow the autonomous yard truck 800 to pull the trailer without individually raising the trailer legs.

In some embodiments, the robotic arm 840 and/or the arm sensor 845 may be coupled with a thermal management system. A thermal management system may, for example, be coupled with a thermal management system associated with the autonomous yard truck 800 such as, for example, coupled with the cab heating/cooling system and/or the engine heating/cooling system. A thermal management system may, for example, be an independent system that heats and/or cools the robotic arm 840 and/or the arm sensor 845. A thermal management system may, for example, keep the temperature of the robotic arm 840 and/or the arm sensor 845 between about 32° F. and about 100° F.

In some embodiments, the autonomous yard truck 800 may include a deployable shade coupled with the back of the cab 801. The deployable shade, for example, may be used to screen the sun and/or other lighting from the arm sensor 845 and/or the one or more backup sensors 864. The deployable shade, for example, may include an umbrella configuration or an awning configuration. The deployable shade, for example, may be coupled with the roof or an upper portion of the cab.

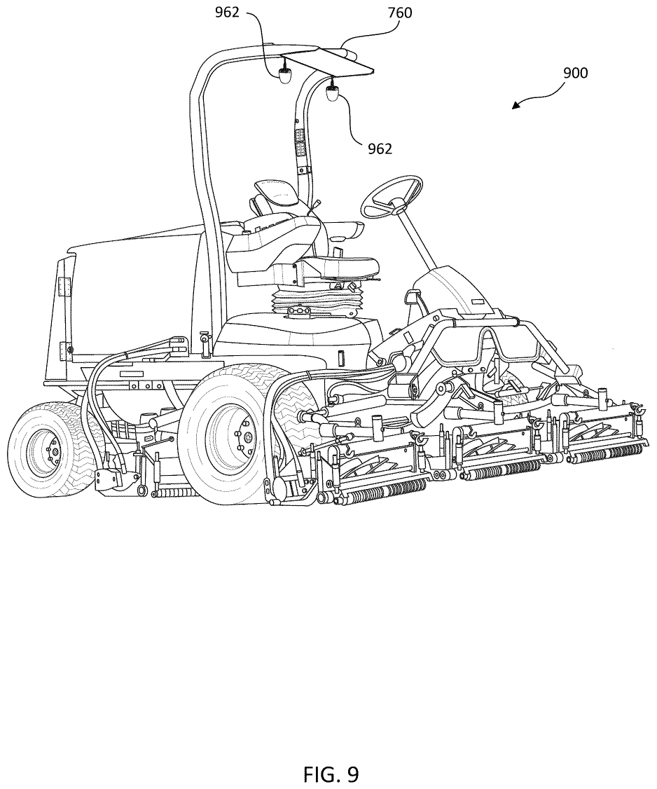

FIG. 9 is a sideview of an example autonomous mower 900, which may include all or some of the components of autonomous vehicle 710. The autonomous vehicle in this document may include the autonomous mower 900. Any type of mower or blades may be used, such as a disc mower. The autonomous mower 900, for example, may include a sensor array 760 (or multiple sensor arrays 760), including sensors 962. The sensor array 760 may include, for example, one or more LiDAR, radar, and/or video cameras. The video cameras, for example, may include 360 degree cameras, a front facing camera, and/or a back facing camera.

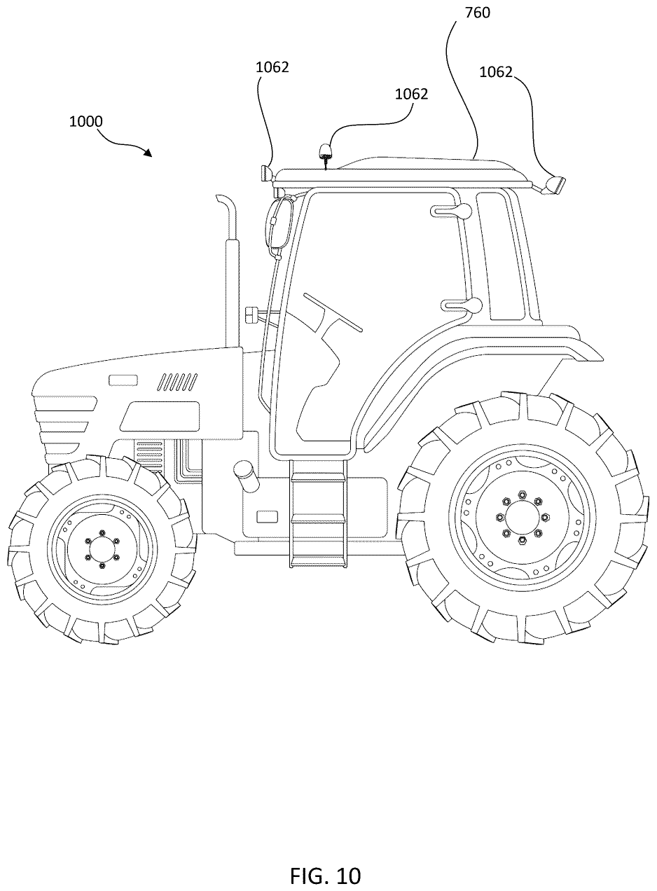

FIG. 10 is a sideview of an example autonomous tractor 1000, which may include all or some of the components of autonomous vehicle 710. The autonomous vehicle in this document may include the autonomous tractor 1000. In this example, the autonomous tractor 1000 may include standard tractor equipment and/or components. The autonomous tractor 1000 may include or be coupled with any kind of implement such as, for example, a plow, disc plow, reel mower, dumper, lift, bucket, shovel, blade, and/or cutter, etc. The autonomous tractor 1000, for example, may include a sensor array 760 (or multiple sensor arrays 760), including sensor(s) 1062. The sensor array 760 may include, for example, one or more LiDAR, radar, and/or video cameras. The video cameras, for example, may include 360 degree cameras, a front facing camera, and/or a back facing camera.

### Additional Terms & Definitions

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous vehicle comprising:
a steering control system for autonomously controlling a driving direction of the autonomous vehicle;
a speed control system for autonomously controlling a speed of the autonomous vehicle;
one or more sensors, including a LiDAR sensor;
one or more processors communicatively coupled with the one or more sensors, the steering control system, and the speed control system; and
one or more computer-readable media having stored thereon instructions that when executed cause the one or more processors to:
receive point cloud data from the LiDAR sensor in predetermined time packets, wherein the point cloud data comprises data points indicating at least a portion of an operating environment;
identify a cluster within the point cloud data, wherein the cluster corresponds to an object within the operating environment and wherein at least one of the data points of the cluster results from a multiple return of a LiDAR beam, and wherein each data point corresponds to a return number that indicates the number of returns obtained from a corresponding LiDAR beam;
calculate a mean return number associated with the cluster based on all returns of the data points within the cluster, wherein the mean return number represents an average of the return numbers for all data points within the cluster,
determine a cluster classification based on the mean return number, wherein the cluster classification represents an object type of the object within the operating environment corresponding to the cluster, and wherein the cluster classification includes at least atmospheric phenomena comprising one of dust, mist, smoke, rain, snow, or fog; and
instruct a steering control system and a speed control system to drive an autonomous vehicle along a path through the operating environment based on the cluster classification.

2. The autonomous vehicle of claim 1, wherein the mean return number is weighted based on an intensity of the point cloud data.

3. The autonomous vehicle of claim 1, wherein determining the cluster classification comprises comparing the mean return number to a return threshold.

4. The autonomous vehicle of claim 1, wherein determining the cluster classification comprises inputting the return numbers of the cluster to a classification process comprising at least one of a logistics regression classification, a decision tree, a random forest learning model, a support vector machine, or a neural network.

5. The autonomous vehicle of claim 4, wherein the classification process is trained to adjust a weight of the return numbers based on at least one of an intensity, reflectivity, elongation, infra-red value, or pulse width of a corresponding point within the cluster.

6. The autonomous vehicle of claim 1, wherein determining the cluster classification is further based on a mean range from the LiDAR sensor to the object corresponding to the cluster, a mean last return ratio (MLRR), a number of points within the cluster, a geometric extent of the cluster, a mean intensity of the points within the cluster, and/or a mean reflectance of the points within the cluster.

7. The autonomous vehicle of claim 1, wherein when the cluster classification indicates an atmospheric phenomena, the instructions further cause the one or more processors to drive the autonomous vehicle along a path through the atmospheric phenomena.

8. The autonomous vehicle of claim 1, wherein when the point cloud data indicate the cluster represents a moving object and the cluster classification indicates an atmospheric phenomena, the instructions further cause the one or more processors to continue to drive the autonomous vehicle along a path in proximity to but not within the atmospheric phenomena.

9. The autonomous vehicle of claim 1, wherein when the cluster classification does not indicate an atmospheric phenomena, the instructions further cause the one or more processors to prevent the autonomous vehicle from driving along a path containing the object, and/or prevent the autonomous vehicle from driving along a path within a proximity threshold of the object.

10. The autonomous vehicle of claim 1, wherein the processor communicates steering commands to a steering mechanism of the steering control system based on the cluster classification.

11. The autonomous vehicle of claim 1, wherein the processor communicates braking commands to a braking mechanism of the speed control system based on the cluster classification.

12. A method for classifying point cloud data, the method comprising:
receiving point cloud data from a LiDAR sensor in predetermined time packets, wherein the point cloud data comprises data points indicating at least a portion of an operating environment;
identifying a cluster within the point cloud data, wherein the cluster corresponds to an object within the operating environment and wherein at least one of the data points of the cluster results from a multiple return of a LiDAR beam, and wherein each data point corresponds to a return number that indicates the number of returns obtained from a corresponding LiDAR beam;
calculating a mean return number associated with the cluster based on all returns of the data points within the cluster, wherein the mean return number represents an average of the return numbers for all data points within the cluster;
determining a cluster classification based on the mean return number, wherein the cluster classification represents an object type of an object within the operating environment; and
instructing a steering control system and a speed control system to drive an autonomous vehicle along a path through the operating environment based on the cluster classification.

13. The method of claim 12, wherein the mean return number is weighted based on an intensity of the point cloud data.

14. The method of claim 12, wherein determining the cluster classification is further based on a mean range from the LiDAR sensor to the object on which the cluster is based from the LiDAR sensor, a mean last return ratio (LRR), a number of points within the cluster, a geometric extent of the cluster, a mean intensity of the points within the cluster, and/or a mean reflectance within of the points within the cluster.

15. The method of claim 12, further comprising, when the cluster classification indicates an atmospheric phenomena, driving the autonomous vehicle along a path in proximity to but not within the atmospheric phenomena.

16. The method of claim 12, further comprising, when the cluster classification does not indicate an atmospheric phenomena, preventing the autonomous vehicle from driving along a path containing the object, and/or preventing the autonomous vehicle from driving along a path within a proximity threshold of the object.

17. An autonomous vehicle comprising:
a steering control system for autonomously controlling a driving direction of the autonomous vehicle;
a speed control system for autonomously controlling a speed of the autonomous vehicle;
one or more sensors, including a LiDAR sensor;
one or more processors communicatively coupled with the one or more sensors, the steering control system, and the speed control system; and
one or more computer-readable media having stored thereon instructions that when executed cause the one or more processors to:
receive point cloud data from the LiDAR sensor in predetermined time packets, wherein the point cloud data comprises data points indicating at least a portion of an operating environment;
identify a cluster within the point cloud data, wherein the cluster corresponds to an object within the operating environment and wherein at least one of the data points of the cluster results from a multiple return of a LiDAR beam, and wherein each data point corresponds to a return number that indicates the number of returns obtained from a corresponding LiDAR beam;
calculate a mean last return ratio (MLRR) based on the multiple returns of the data points, wherein the MLRR is determined according to a function comprising:
$$M L R R = \frac{{\sum }_{j = 1}^{j = p} 1 - \frac{{r}_{j} - ( {i}_{j} + 1 )}{{r}_{j}}}{p}$$
wherein p represents a total number of points within the cluster, rᵢ represents a number of returns r at data point j, and iⱼ represents a return index i at data point j;
determine a cluster classification based on the MLRR, wherein the cluster classification represents an object type of the object within the operating environment; and
instruct a steering control system and a speed control system to drive an autonomous vehicle along a path through the operating environment based on the cluster classification.

18. The autonomous vehicle of claim 17, wherein the MLRR is weighted based on an intensity of the point cloud data.

19. The autonomous vehicle of claim 17, wherein determining the cluster classification comprises comparing the MLRR to a return threshold.

20. The autonomous vehicle of claim 17, wherein determining the cluster classification comprises inputting the MLRR of the cluster to a classification process comprising at least one of a logistics regression classification, a decision tree, a random forest learning model, a support vector machine, or a neural network.
